(19) United States
(12) Patent Application Publication
(10) Pub. No.: US 2003/0036412 A1
(43) Pub. Date: Feb. 20, 2003

(54) Electro-luminescent device for a mobile phone

(76) Inventor: Sze-Huen Chong, Taipei City (TW)

Correspondence Address: Sze-Huen Chong, PO Box 82-144, TAIPEI, TW

(21) Appl. No.: 09/931,742

(22) Filed: Aug. 20, 2001

(51) Int. Cl. H04M 1/00

(52) U.S. Cl. 455/566; 455/550

(57) ABSTRACT

An electroluminescent device of a mobile phone is disclosed. The electro-luminescent device of a mobile phone having a battery compartment comprises a luminescent disc disposed on the battery compartment of the mobile phone; a signal-receiving unit for receiving high frequency signals of the mobile phone; an automatic control unit connected to the signal-receiving unit for filtering, rectification of the corresponding high frequency signals and for the production of flickering signal and for calculation; a display-switching driving unit connected to the automatic control unit and the luminescent disc to drive the luminescent disc; and a reverse-change voltage-elevating unit connected to the automatic control unit and the luminescent disc to provide the high voltage required by the luminescent disc. The driving of the voltage-elevating unit and the display-switching driving unit causes the luminescent disc to produce various animations and patterns when the mobile phone receives incoming signals.

### BACKGROUND OF THE INVENTION

(a) Field of the Invention

The present invention relates to an electroluminescent device for a mobile phone, and in particular, a luminescent device which produces animated pictures when an incoming call is received.

(b) Description of the Prior Art

In conventional mobile phones, an incoming call is only displayed on the mobile phone screen with symbols or characters to indicate the incoming call, and besides, the color of displayed pattern is fixed single color and there is little changes on the patterns.

Therefore, it is an object of the present invention to provide an electro-luminescent device for a mobile phone which produces animated patterns and the patterns can be changed.

After conducting a search for relevant patents, the applicant found the following two U.S. patents (U.S. Pat. No. 5,754,064 to Chien and U.S. Pat. No. 6,073,034 to Jacobsen et al). However, even if these two references are combined together, the combined disclosure still fails to disclose the present invention in light of the following reasons:

The Chien reference discloses an electro-luminescent device comprising a controller circuit including a signal receiving unit, an electro-luminescent means flashing and driving controller unit, and a driving unit being electrically connected sequentially, and an electroluminescent means being connected to the controller circuit, wherein the electro-luminescent means is flashed when a signal is received. The Jacobsen et al reference discloses an electro-luminescent means provided on the surface of the mobile phone and the electroluminescent device is electrically connected to the mobile phone.

However, none of the cited references disclose an electroluminescent device for a mobile phone having the following characteristics:

1. The present invention utilizes RF signal to trigger and control the flashing of the electro-luminescent means, while the references use commonly used button for switching and triggering.

2. The present invention utilizes RCL oscillation which is different from the references.

3. The present invention utilizes RF signal to activate the electro-luminescent means flashing controller thereby achieving the energy saving control purpose, which is different from the references.

4. The present invention is supplied by the battery power (2.4-4.2 v) of the mobile phone, whereas the references are powered by dry cells (1.5-3 v).

5. The present invention can drive an area of 15 cm², which is much stronger than the references.

6. The present invention is used with a mobile phone, while the references are for other general purposes.

7. The present invention utilizes signal reception to trigger thereby making it suitable for use with mobile phones.

8. The references disclose LED circuits which are completely different from the present invention.

### SUMMARY OF THE INVENTION

Accordingly, it is an object of the present invention to provide an electroluminescent device for a mobile phone, wherein various luminescent animated pictures or images are formed on the housing of the mobile phone when the mobile phone receives an incoming call.

Yet another object of the present invention is to provide an electro-luminescent device for a mobile phone comprising a luminescent disc having various patterns, and circuits of automatic control unit, a reverse-change voltage-elevating unit and a display-switching driving unit so as to drive the luminescent disc to produce the change of luminescent patterns.

A further object of the present invention is to provide an electroluminescent device for a mobile phone, wherein a signal-receiving unit is provided to receive high frequency signals of incoming call to activate the automatic control unit to ignite the luminescent disc.

Yet another object of the present invention is to provide an electroluminescent device for a mobile phone, wherein the automatic control unit is provided with oscillation circuit to produce flickering signals causing the luminescent change of the patterns of the luminescent disc.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view illustrating the electroluminescent device for a mobile phone implemented onto a mobile phone in accordance with the present invention.

FIG. 2 is a perspective exploded view of the electroluminescent device for a mobile phone in accordance with the present invention.

FIG. 3 is a block diagram of the circuit in accordance with the present invention.

FIG. 4 is the circuit diagram of the preferred embodiment of the present invention.

FIG. 5 shows the time sequence waveform of the circuit in accordance with the present invention.

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

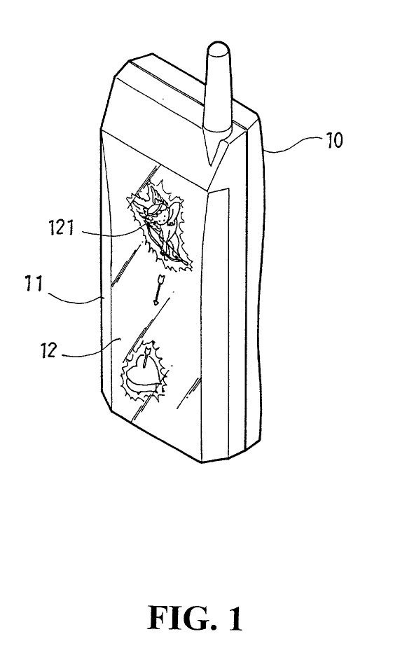

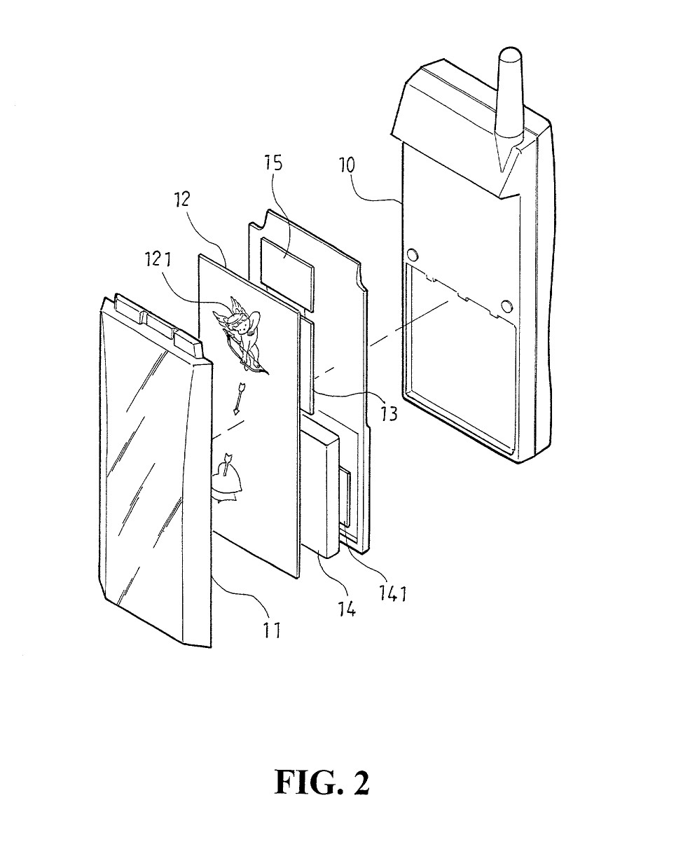

Referring to FIGS. 1 and 2, there is shown an electro-luminescent device of a mobile phone 1 having a battery chamber 11 (transparent). A luminescent disc 12 having various patterns 12 is provided within the battery chamber 11. The luminescent disc 12 is adhered onto the inner edge of the battery chamber 11 and is connected to a control circuit board 13, and the circuit board 13 is connected to a battery 14 having a power protection circuit board 14, and a Lithium battery protection board 15 so that during changing power source first passes to the protection board 15 and then to the mobile phone. This provides a protection and is suitable for all kinds of mobile phones. After combination, the battery compartment 11 engaged with the mobile phone 10 will provide the require voltage, and by means of the control circuit board 13 to sense the high frequency signals to drive the luminescent disc 12 to change luminescent animated pictures, thereby, it provides an indication or a display of incoming call.

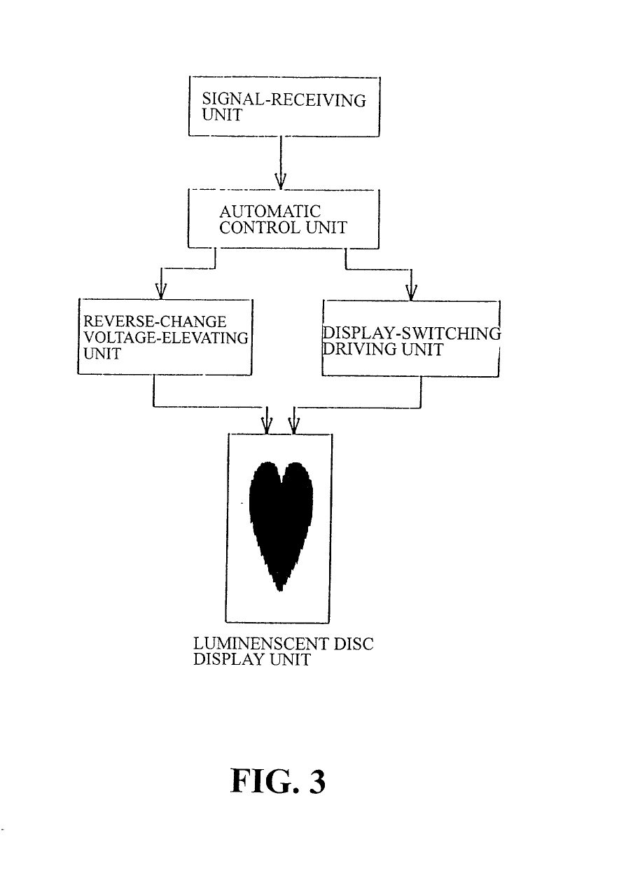

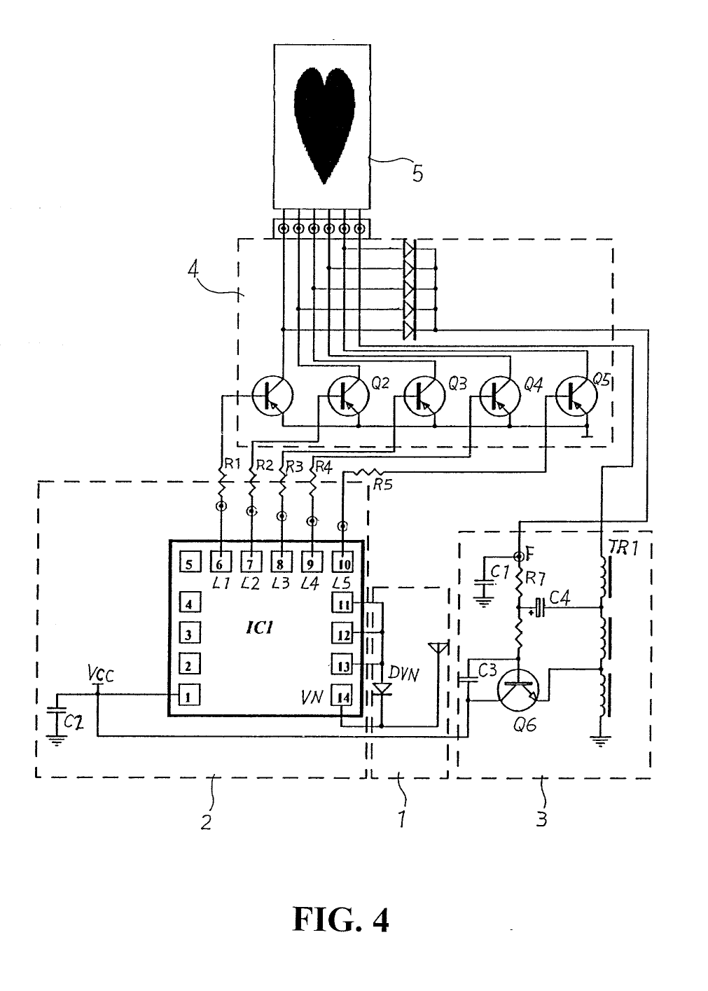

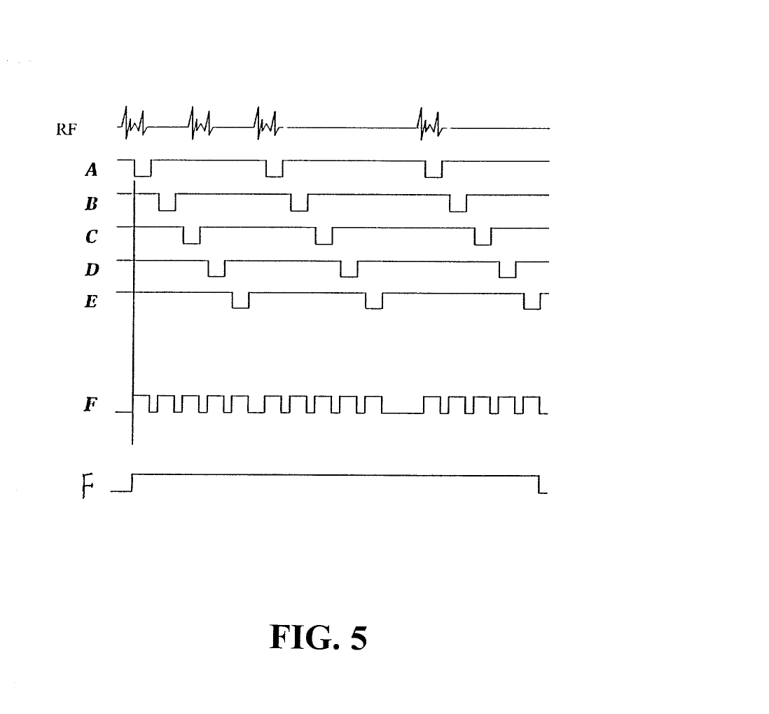

Referring to FIGS. 3 and 4, the control circuit of the present invention comprises a signal-receiving unit 1, an automatic control unit 2, a reverse-change voltage-elevating unit 3, a display-switching driving unit 4 and a luminescent disc display unit 5, when there is an incoming call, a high frequency signal is produced, DVN terminal will sense the signal, and via the activation of the VN terminal of IL1, the internal of IL1 proceeds to filter, rectify the high frequency signal to produce activation signal to control the internal oscillation circuit to output flickering signals and at the same time to activate the timing circuit. The flickering signals are output from L1 to L5 (point A, B, C, D, E of FIG. 5) and at the same time output signals Q1 to Q5. D1 to D5 initiated the reverse-change voltage-elevating unit 3 at each section of luminescent disc. That is, F point is provided with voltage when L1 to L5 flash, and R6, R7, C3, C4, Q6 and TR1 are formed into a RCL oscillation driving circuit, so that when F point is provided with control signal, the voltage needed by the luminescent disc is output.

The shape of wave of the F point voltage is shown in FIG. 5(b). The F point is a pulse voltage so as to reduce the current in the course of driving. FIG. 5C shows the F point voltage of the conventional luminescent disc control circuit, and is a direct current control voltage, thus, the current of the circuit at loading is increased. The type shown in FIG. 5(b) shows, under similar driving load, 10 MA to 20 MA of working current is saved.

When the internal timing of the IL1 of the automatic control unit 2 has reached the preset value, the flickering signals stop, and at the same time, the individual circuit are switched to low power consumption and in standby status.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An electro-luminescent device of a mobile phone having a battery compartment comprising
a luminescent disc disposed on the battery compartment of the mobile phone;
a signal-receiving unit for receiving high frequency signals of the mobile phone;
an automatic control unit connected to the signal-receiving unit for filtering, rectification of the corresponding high frequency signals and for the production of flickering signal and for calculation;
a display-switching driving unit connected to the automatic control unit and the luminescent disc to drive the luminescent disc; and
a reverse-change voltage-elevating unit connected to the automatic control unit and the luminescent disc to provide the high voltage required by the luminescent disc.

2. The electroluminescent device of a mobile phone of claim 1, wherein the display switching driving unit includes a plurality of transistors and a diode.

3. The electro-luminescent device of a mobile phone of claim 2, wherein the reverse-change voltage-elevating unit is a RCL oscillation circuit includes resistance, capacitance and transformers.
